(19) United States
(12) Patent Application Publication
(10) Pub. No.: US 2021/0075247 A1
(43) Pub. Date: Mar. 11, 2021

(54) Process that creates energy

(71) Applicant: Curtis Ginder Jones, Eureka, IL (US)

(72) Inventor: Curtis Ginder Jones, Eureka, IL (US)

(21) Appl. No.: 16/873,949

(22) Filed: Aug. 24, 2020

Related U.S. Application Data
(60) Provisional application No. 62/922,831, filed on Aug. 29, 2019.

(51) Int. Cl. H02J 7/34; H02J 7/00

(52) U.S. Cl. CPC H02J 7/345; H02J 7/0013

(57) ABSTRACT

What is new with this invention is that the process being submitted allows for a device to be made that produces more energy coming out of the device than energy going into the device. This is done by connecting capacitors in certain ways that allow a current to flow between them spontaneously and therefore no additional energy is required to make the excess energy.

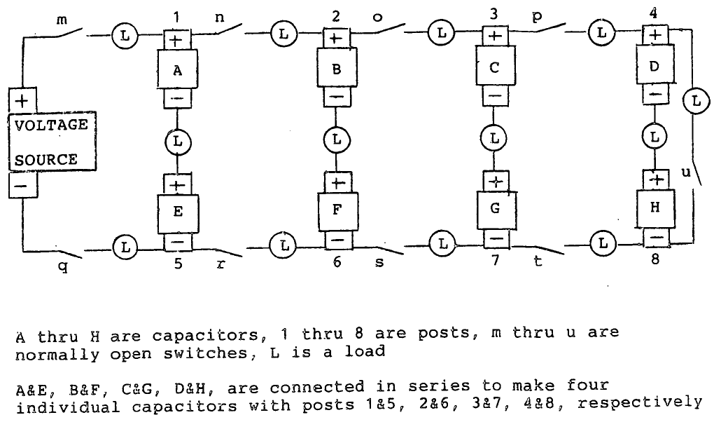

### REFERENCE TO RELATED APPLICATIONS

See application data sheet

### FEDERALLY SPONSORED RESEARCH OR DEVELOPMENT

Not applicable

### REFERENCE TO LISTING

Not applicable

### BACKGROUND OF THE INVENTION

One version of the background of this invention starts with a capacitor. A load was put in the circuit that traditionally charged the capacitor and it performed ok and the capacitor came to the same voltage as the source. Then a load was put in the discharge circuit and it performed ok. The next thing that was tried was to charge one capacitor with another capacitor (parallel connection). It was eventually learned that whenever two capacitors of unequal voltages are connected in parallel they both come to the same voltage if given enough time. This eventually led to the duplication of the initial charge without any further input of energy. Another thing that was tried was to make one capacitor out of two or more capacitors that are connected in series. This also led to the duplication of the initial charge without any further input of energy. It has also been calculated that the energy of a “transfer” could be made larger than the energy used in the capacitor.

This application might fall in the CPC Y02E 70/00.

### BRIEF SUMMARY OF THE INVENTION

The process takes a segment of electrically charged particles (Q) and moves them spontaneously through a conductor from one point to another point (“transfer”). The heat and electromagnetic field of the “transfer” is the created energy and its amount depends on the size of Q. Q comes from capacitance multiplied by voltage. In other words, what is in play is Q=CV and not V=IR. With little resistance, most of the energy comes from the amperage and is measured by IsquaredRT. Take note that the amperage is decreasing so that has to be taken into account. As noted in the background section of this specification, “transfers” can be made when two capacitors are connected in parallel and “transfers” can be made when one capacitor can be replaced by two or more capacitors in series. This allows for many replications of “transfers” without any further outside input of energy.

The advantage of the process is to have a way to make more energy come out of a system than is going into the system.

The object of the invention is to have large amounts of clean, viable, versatile, inexpensive energy.

### BRIEF DESCRIPTION OF THE DRAWING

The drawing is an illustration of one of many setups that would show how the process works.

### DETAILED DESCRIPTION OF THE INVENTION

Start the process with all the capacitors at zero voltage.

Step 1—Charge A&E by closing switches m&q. Voltage source and A&E try to come to the same voltage depending on the time allowed.

Step 2—Open switches m&q and then close switches n&r. A&E and B&F try to come to the same voltage depending on the time allowed.

Step 3—Open switches n&r and then close switches o&s. B&F and C&G try to come to the same voltage depending on the time allowed.

Step 4—Open switches o&s and then close switches p&t. C&G and D&H try to come to the same voltage depending on the time allowed.

Step 5—Open switches p&t and then close switch u. D&H tries to go to zero (discharge) depending on the time allowed.

Now, to continue on, keep repeating steps 1 thru 5.

The process always attempts to match the discharge Q to the charge Q. Every L on the illustration will produce energy when activated because a certain number of charged particles will go spontaneously from one post to another post. Any number of capacitors can be used in the parallel situation and any number of capacitors can be used in the series situation. The time, voltage, capacitance, and resistance are all variable and can change the performance.

1. The claim is on any process that uses the “transfer” or “transfers” to create excess energy.
